(19) United States
(12) Patent Application Publication
(10) Pub. No.: US 2020/0361649 A1
(43) Pub. Date: Nov. 19, 2020

(54) REEL PROVIDED WITH A PACKAGING MATERIAL, AND A FILLING MACHINE FOR FILLING A PACKAGING MATERIAL WITH A FOOD PRODUCT

(71) Applicant: Tetra Laval Holdings & Finance S.A., Pully (CH)

(72) Inventors: Antonio Melandri, Rubiera (IT); Paolo De Corte, Modena (IT); Marco Magnani, Reggio Emilia (IT); Stefano Vicini, Vignola (IT)

(21) Appl. No.: 16/988,035

(22) Filed: Aug. 7, 2020

Related U.S. Application Data
(62) Division of application No. 15/739,659, filed on Dec. 22, 2017.

(30) Foreign Application Priority Data
Jun. 23, 2015 (SE) 1550861-7

(51) Int. Cl. B65B 41/12; B65B 57/02; B65H 75/18; H01Q 1/22; H01Q 19/10

(52) U.S. Cl. CPC B65B 41/12; B65B 57/02; B65H 2553/52; H01Q 1/2225; H01Q 19/10; B65H 75/182

(57) ABSTRACT

The disclosure relates to a reel provided with a packaging material. The reel may be adapted to be mounted on a mandrel of a filling machine. The reel may be hollow and have the shape of a cylinder, an inner portion of which may be provided with a tag containing information at least associated with the packaging material. The disclosure also relates to a filling machine for filling a packaging material with a food product.

### TECHNICAL FIELD

The invention relates to a reel provided with a packaging material, and a filling machine for filling a packaging material with a food product.

### BACKGROUND ART

In the packing industry for packing food content, packages are often made by carton based multi-layer material that is folded and sealed into packages into which food content is placed. For most food packing machines of carton based packages, the packaging material, e.g. complex multi-layer packaging material, are provided in large rolls with packaging material where each roll or reel contains packaging material for a large number of packages, often thousands of packages. The large reels with packaging material are pre-printed according to the food product that is filled into the package. The multi-layer packaging material also contains different layers depending on the product that is intended to be stored in the package. Some packaging materials are made for fresh products intended to keep chilled and to consume in a relatively near future, while other packing materials are for packages that are aseptic for storing food products for long periods of time. It is thus important that the correct packaging material is used for the intended product, both so that the correct print end up on the correct packaged product but also so that the correct type of packaging material is used for the product. The reels with packaging material are often fed to the packing or filling machine by a so called automatic splicing unit comprising two mandrels each intended to receive a reel with packaging material. When one reel is empty, the automatic splicing unit will automatically splice the beginning of the packaging material of the second reel onto the end of the packaging material of the first reel.

If an incorrect reel is introduced into the automatic splicing unit and the incorrect reel is used, the filling machine has to be stopped with and the filling machine has to be cleaned before starting again, which may invoke large costs and result in a lot of wasted product.

There is thus a need for an improved system for handling packaging materials so as to reduce the risk of using a reel with incorrect packaging material.

### SUMMARY OF THE INVENTION

It is an object of the present invention to improve the current state of the art, to solve the above problems, and to provide improvements relating to packaging of food products. These and other objects are achieved by a reel provided with a packaging material. The reel is adapted to be mounted on a mandrel of a filling machine, wherein said reel is hollow and has the shape of a cylinder, an inner portion of which is provided with a tag containing information at least associated with said packaging material. Thus, any necessary information relating to the reel or its packaging material may be stored in the tag. The information may then be read by a user or automatically by the filling machine when the reel is mounted on the same. This way, the risk of providing the filling machine with incorrect settings or providing the filling machine with the wrong type of reel and packaging material will be eliminated.

The tag may be arranged flat on said inner portion and positioned such that an induction antenna of said tag has a maximized cross-sectional area directed towards a transceiver adapted to communicate with said tag. This will optimize the communication between the tag and the transceiver adapted to communicate with the tag.

According to a second aspect, these and other objects are achieved, in full or at least in part, by a filling machine for filling a packaging material with a food product. The filling machine comprises a mandrel adapted to receive a reel provided with said packaging material, and a transceiver adapted to communicate with a tag provided in said reel in order to receive information stored in said tag. The mandrel comprises an outer groove which extends along a circumference of said mandrel and at least corresponds to a shape of said tag, such that a clearance is created between said mandrel and said tag in the axial and radial direction of said mandrel when said reel is mounted on said mandrel to avoid mechanical interference between said mandrel and said tag. Since the size of the tag is completely overlapped by the outer groove of the mandrel, in both the axial and radial direction in relation to the groove, there will be no mechanical interference between the mandrel and the tag. Thus, the risk of damaging or removing the tag unwillingly will be eliminated.

The filling machine may further comprise a packaging device adapted to provide a package from said packaging material, whereafter said filling machine fills said package with the food product.

Preferably, the outer groove may extend along the entire circumference of said mandrel. This way, there will be no mechanical interference between the mandrel and the tag even if the two parts should start to glide in relation to each other during rotation.

The mandrel may be manufactured by a radio frequency transparent material in order to avoid interference of the radio communication between the transceiver and the tag. In a preferred embodiment, the radio frequency transparent material may be nylon. In turn, the tag may be an RFID tag. The RFID tag may be a HF-tag, a UHF-tag or an NFC-tag.

The filling machine may further comprise a control unit adapted to control said filling machine based on information retrieved from said tag. Accordingly, the process of reading the information stored in the tag and controlling the filling machine based thereof may be completely automated. Should a reel with the wrong type of packaging material be mounted on the mandrel of the filling machine it will be registered by the control unit, which in turn could trigger an alarm or the like.

The filling machine may further comprise a metal plate arranged on a back side of said transceiver adapted to reflect radio frequency radiation in the transmission direction of said transceiver and to shield from radio frequency radiation in the direction opposite to said transmission direction. Such a construction will increase the quality of the communication signals between the transceiver and the tag. The metal plate may also be arranged adjacent to and/or surrounding said reel. In one preferred embodiment, the metal plate is one comprised in the group consisting of a grid, a plate, a plate with apertures. The apertures may have a diameter smaller than 50 mm.

The transceiver may be arranged adjacent to said mandrel and near the central axis of said mandrel such that the path between said transceiver and said tag is not hindered by said reel.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

### BRIEF DESCRIPTION OF THE DRAWINGS

The above objects, as well as additional objects, features and advantages of the present invention, will be more fully appreciated by reference to the following illustrative and non-limiting detailed description of preferred embodiments of the present invention, when taken in conjunction with the accompanying drawings, wherein:

FIG. 1 is a perspective view of a filling machine according to one exemplary embodiment of the invention.

FIG. 2a is a perspective view of a mandrel of the filling machine in FIG. 1.

FIG. 2b is a top view of the mandrel in FIG. 2a.

FIG. 3 is a perspective view a transmitter of the filling machine in FIG. 1.

FIG. 4 is a perspective view of a reel according to one exemplary embodiment of the invention.

### DETAILED DESCRIPTION OF PREFERRED EMBODIMENTS OF THE INVENTION

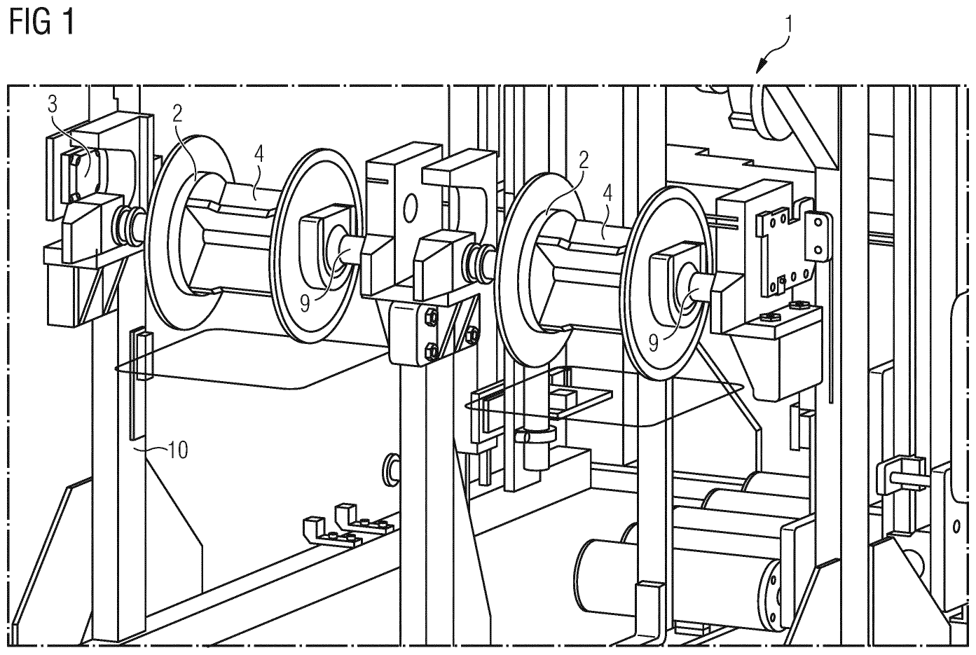

FIG. 1 shows a filling machine 1 for filling a packaging material 7 with a food product, having a mandrel 2 adapted to receive a reel 5 provided with packaging material 7. Referring to both FIG. 1 and FIG. 4, the filling machine 1 is equipped with a transceiver 3 adapted to communicate with a tag 6 provided in said reel 5 in order to receive information stored in said tag 6. The mandrel 2 has an outer groove 4 such that a clearance is created between the mandrel 2 and a tag 6 when a reel 5 is mounted on the mandrel 2 to avoid mechanical interference between the mandrel 2 and the tag 6. The mandrels 2 are mounted on shafts 8 which in turn are mounted in a frame 10 of the filling machine 1. The transceiver 3 is placed near the real core cylinder of the reel 5 so as to transmit a radio signal along the centre of the reel 5 with packaging material 7 so that the packing material 7 will not shield off the radio signal as the packaging material 7 may include metallic layers. The mandrel 2 is further preferably made of a radio frequency transparent material such as nylon to not block the radio signals in the communication between the transceiver 3 and the tag 6. Nylon is a generic designation for a family of synthetic polymers, more specifically aliphatic or semi-aromatic polyamides (PA). They can be melt-processed into fibers, films or shapes. Polyamides are semi-crystalline polymers. A distinction is made between two types. Polyamides made of one basic material, then the material is described as Nylon x, where x is a single digit, and polyamides, which are made of 2 basic materials, where the material is described as Nylon xx, where xx corresponds to a two-digit number. Polyamides have very good mechanical properties and are particularly tough. Properties vary from the hard and tough Nylon 66 to the soft and flexible Nylon 6. Depending on the type, polyamides absorb different amounts of moisture, which also affect the mechanical characteristics as well as the dimensional accuracy. The nylon used for the manufacturing of the mandrel can advantageously be Nylon 66, which is a material well defined in the plastic industry. This material is a good composition for this purpose because it has been proven to have both the mechanical strength and to be a radio frequency transparent material.

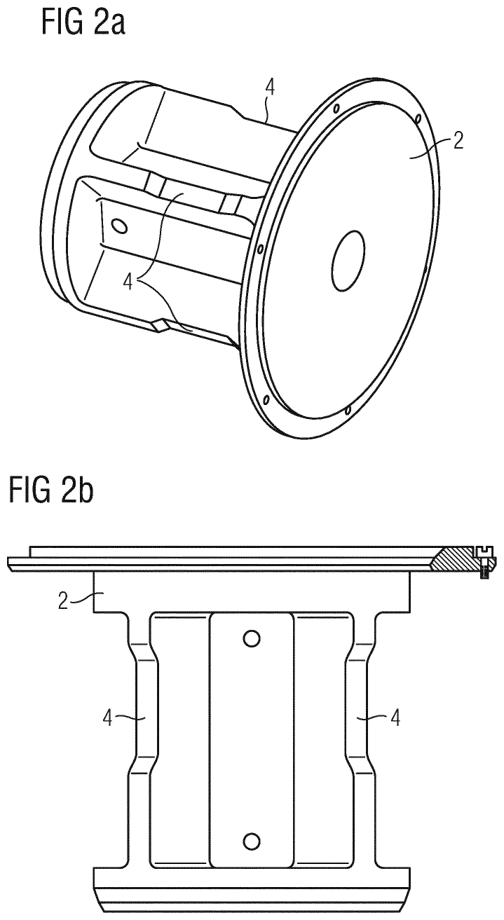

FIG. 2a is a perspective view of the mandrel 2 according to the present invention and FIG. 2b is a cross-sectional view of the mandrel 2. The groove 4 is clearly shown in FIG. 2a and FIG. 2b. Referring to FIG. 2a, FIG. 2b and FIG. 4, the tag 6 in the core of the reel 5 is positioned so that the tag 6 is placed over the groove 4. If a reel 5 is placed on the mandrel 2 the tag 6 will be placed over the groove 4 so that the tag 6 is not in contact with the mandrel 2. If the reel 5 should slip against the mandrel 2, the tag 6 will not be damaged since no contact will occur between the mandrel 2 and the tag 6.

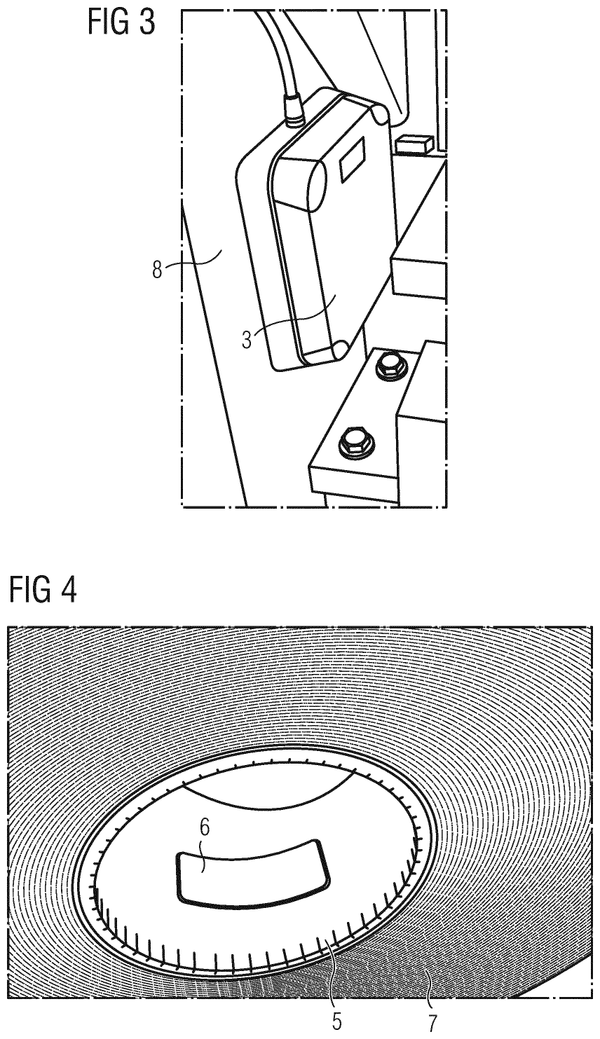

FIG. 3 is a picture of the transceiver 3. A metal plate 8 is arranged on a back side of said transceiver 3 adapted to reflect radio frequency radiation in the transmission direction of said transceiver 3 and to shield radio frequency radiation in the direction opposite to said transmission direction so that the surrounding on the back side of the transceiver 3 radiated with radio signals. The metal plate 8 also shields the transceiver 3 from other transceivers and other radio transmitters.

FIG. 4 shows a reel 5 with packaging material 7 rolled around the centre core cylinder of the reel 5. Inside the reel centre core cylinder a tag 6 is arranged. The tag 6 is in FIG. 4 rectangular and oblong and having an antenna (not shown) for receiving an induction radio signal and for sending a response to an induction radio signal. The antenna (not shown) is arranged under the top side of the tag 6 covering most of the area of the tag 6. The tag 6 is positioned with its length side perpendicular to the centre axis of the reel so as to optimize the area of the antenna (not shown) of the tag that is exposed to the radio signal from the transceiver 3 (FIG. 1).

1. (canceled)

2. (canceled)

3. A filling machine for filling a packaging material with a food product, comprising:
a mandrel adapted to receive a reel provided with said packaging material, and a transceiver adapted to communicate with a tag provided in said reel in order to receive information stored in said tag, wherein said mandrel comprises an outer groove which extends along a circumference of said mandrel and at least corresponds to a shape of said tag, such that a clearance is created between said mandrel and said tag when said reel is mounted on said mandrel.

4. The filling machine according to claim 3, wherein said outer groove extends along the entire circumference of said mandrel.

5. The filling machine according to claim 3, wherein said mandrel is manufactured by a radio frequency transparent material.

6. The filling machine according to claim 5, wherein said radio frequency transparent material is nylon.

7. The filling machine according to claim 3, wherein said tag is an RFID tag.

8. The filling machine according to claim 3, further comprising a control unit adapted to control said filling machine based on information retrieved from said tag.

9. The filling machine according to claim 3, further comprising a metal plate arranged on a back side of said transceiver the metal plate configured to reflect radio frequency radiation in the transmission direction of said transceiver and to shield from radio frequency radiation in a direction opposite said transmission direction.

10. The filling machine according to claim 3, further comprising a metal plate arranged at least one of adjacent to and surrounding said reel.

11. The filling machine according to claim 9, wherein said metal plate is selected from the group consisting of a grid, a plate, and a plate with holes.

12. The filling machine according to claim 11, wherein said metal plate comprises apertures with a diameter smaller than 50 mm.

13. The filling machine according to claim 3, wherein said transceiver is arranged adjacent to said mandrel and near the central axis of said mandrel, the arrangement configured such that said reel does not interfere with a radio communication path between said transceiver and said tag.
